(19) United States
(12) Patent Application Publication
(10) Pub. No.: US 2025/0308172 A1
(43) Pub. Date: Oct. 2, 2025

(54) VIRTUAL OBJECT DATA SELECTION APPARATUS

(71) Applicant: NTT DOCOMO, INC., Tokyo (JP)

(72) Inventors: Ryousuke KURACHI, Chiyoda-ku (JP); Kei ISHIGURO, Chiyoda-ku (JP); Fuminori SHINSEI, Chiyoda-ku (JP); Masayuki YOKOO, Chiyoda-ku (JP); Masashi KANAUCHI, Chiyoda-ku (JP)

(73) Assignee: NTT DOCOMO, INC., Tokyo (JP)

(21) Appl. No.: 18/866,270

(22) PCT Filed: May 18, 2023
(86) PCT No.: PCT/JP2023/018587

§ 371 Date: Nov. 15, 2024

(30) Foreign Application Priority Data
May 23, 2022 (JP) 2022-083551

(51) Int. Cl. G06T 19/00; G06F 3/01

(52) U.S. Cl. CPC G06T 19/006; G06F 3/011

(57) ABSTRACT

A selector selects at least one piece of virtual object data from plural pieces of virtual object data based on first location information, first shape information, plural pieces of second shape information, and plural pieces of second location information. The first location information indicates a location of a user in a real space. The first shape information indicates a shape of a real object located in the real space. Each piece of second shape information indicates a shape of a corresponding one of the virtual objects. Each piece of second location information indicates a location in which a corresponding one of the virtual objects is arranged in the real space. A transmission controller transmits virtual object data to a display device. The selector estimates at least one visible object visually recognizable from the location of the user and selects virtual object data corresponding to the at least one visible object as the at least one piece of virtual object data.

### TECHNICAL FIELD

The present invention relates to a virtual object data selection apparatus.

### BACKGROUND ART

XR (Extended Reality) technologies have been widespread in recent years. XR is a general term for AR (Augmented Reality), VR (virtual reality), MR (Mixed Reality), and the like. For example, Patent Document 1 discloses a VR contents management system. A server apparatus converts object data in a specific format into object data in a common format different from the specific format. The server apparatus manages VR contents including the object data in the common format and a configuration file. A contents creation apparatus creates VR contents including the object data in the common format and the configuration file downloaded from the server apparatus. The contents creation apparatus uploads the configuration file to the server apparatus. A viewing apparatus downloads VR contents for a viewer from the server apparatus and provides the viewer with a virtual and immersive experience in the downloaded VR contents.

### RELATED ART DOCUMENT

### Patent Document

Patent Document 1: Japanese Patent Application Laid-Open Publication No. 2019-168934

### SUMMARY OF THE INVENTION

### Problem to be Solved by the Invention

Generally, virtual object data is transmitted to an XR device in each area set in a real space or a virtual space. That is, when a user carrying an XR device enters an area, a plurality of virtual object data for all virtual objects arranged in the area are transmitted. However, when the visibility in the area is not good, all the virtual objects in such an area are not always visually recognized by the user. Some virtual object data transmitted to the XP device may not be used. In some cases, an extremely large virtual object may not be transmitted until the user enters an area, even though the virtual object is also visible from outside the area.

An object of the present invention is to efficiently transmit and receive virtual object data.

### Means of Solving the Problems

A virtual object data selection apparatus according to one aspect of the present invention includes: a selector configured to select at least one piece of virtual object data from plural pieces of virtual object data corresponding one-to-one to a plurality of virtual objects based on: first location information indicative of a location of a user in a real space; first shape information indicative of a shape of a real object located in the real space; plural pieces of second shape information, each indicative of a shape of a corresponding one of the plurality of virtual objects; and plural pieces of second location information, each indicative of a location in which a corresponding one of the plurality of virtual objects is arranged in the real space; and a transmission controller configured to transmit the at least one piece of virtual object data selected by the selector to a display device. The display device is configured to display a virtual object based on the at least one virtual object data to be superimposed on a viewing range of the user in the real space. The selector is configured to: estimate at least one visible object visually recognizable from the location of the user from among the plurality of virtual objects; and select virtual object data corresponding to the at least one visible object as the at least one piece of virtual object data.

### Effect of the Invention

According to one aspect of the present invention, it is possible to efficiently transmit and receive virtual object data.

### BRIEF DESCRIPTION OF THE DRAWINGS

FIG. 1 is a block diagram illustrating a configuration of a system 1 according to an embodiment.

FIG. 2 is a block diagram illustrating a configuration of a terminal apparatus 10.

FIG. 3 is a block diagram illustrating a configuration of a server apparatus 20.

FIG. 4 is a plan view illustrating a location relationship of objects in a virtual object map MP.

FIG. 5 is a schematic diagram illustrating the virtual object map MP.

FIG. 6 is a flowchart illustrating an operation of a processing device 206.

### MODES FOR CARRYING OUT THE INVENTION

### A. Embodiment

### A-1. System Configuration

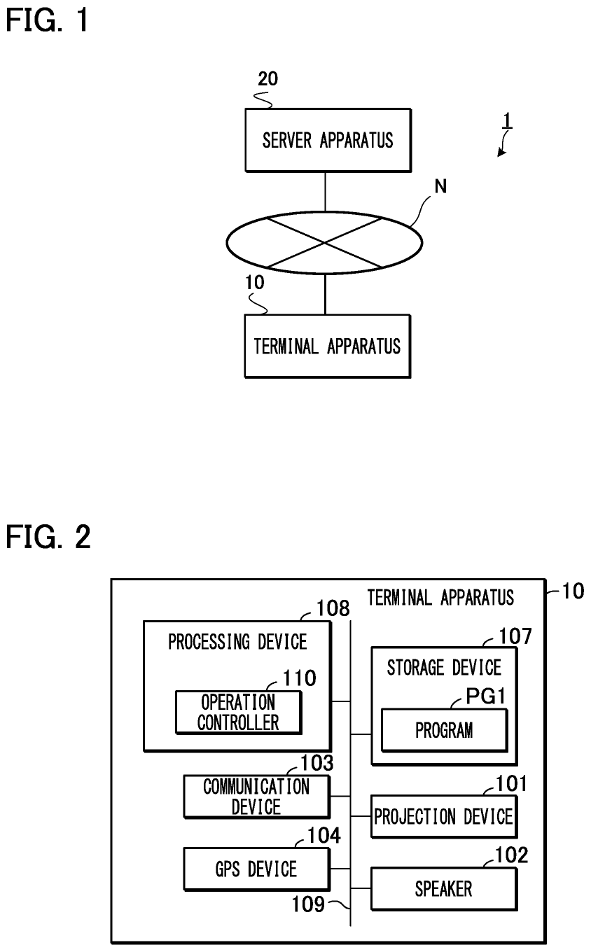

FIG. 1 is a block diagram illustrating a configuration of a system 1 according to an embodiment. The system 1 includes a terminal apparatus 10 and a server apparatus 20. The terminal apparatus 10 is one example of a display apparatus, and the server apparatus 20 is one example of a virtual object data selection apparatus. The terminal apparatus 10 and the server apparatus 20 are connected to each other via a network N. Only one terminal apparatus 10 is illustrated in FIG. 1; however, the system 1 may include any number of terminal apparatuses 10.

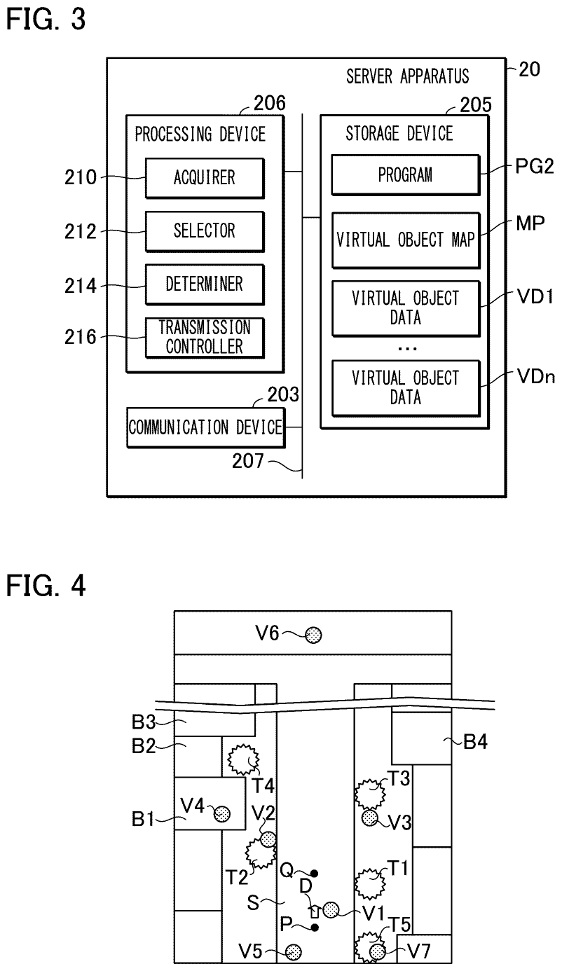

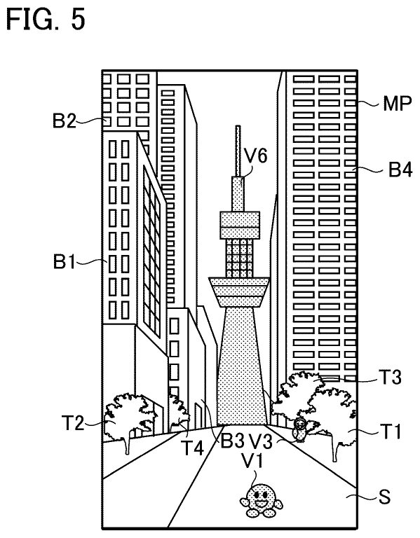

In this embodiment, the system 1 provides a user carrying the terminal apparatus 10 with a variety of types of information using the AR technology. The AR technology enables a user to visually recognize virtual objects as existing in the real space by imposing the virtual objects on a real-world view. That is, the terminal apparatus 10 superimposes virtual objects V (see FIG. 5) on the real-world view of a user based on virtual object data VD (see FIG. 3). Examples of the virtual object include a still image, a video, a three-dimensional computer graphics (3D CG) model, and a text. The terminal apparatus 10 may output other types of information, such as spoken sound, when displaying the virtual objects V.

Examples of the terminal apparatus 10 include a see-through head-mounted display, a portable information device, such as a smartphone and a tablet. In this embodiment, the terminal apparatus 10 is envisaged to be a see-through head-mounted display. The server apparatus 20 stores therein pieces of virtual object data VD to display virtual objects on the terminal apparatus 10. The pieces of virtual object data VD correspond one-to-one to different virtual objects V. The terminal apparatus 10 receives virtual object data VD from the server apparatus 20 and displays a virtual object V corresponding to the received virtual object data VD.

### A-2. Terminal Apparatus 10

FIG. 2 is a block diagram illustrating a configuration of the terminal apparatus 10. The terminal apparatus 10 has the substantially the same shape as that of general eyeglasses. The terminal apparatus 10 has a left lens in front of the left eye of a user, a right lens in front of the right eye of the user, and a frame that supports the left and right lenses. The frame has a bridge between the right and left lenses, and a pair of temples resting over the right and left ears.

The terminal apparatus 10 includes a projection device 101, a speaker 102, a communication device 103, a GPS device 104, a storage device 107, a processing device 108, and a bus 109. The components illustrated in FIG. 2 are, for example, stored in the frame. The projection device 101, the speaker 102, the communication device 103, the GPS device 104, the storage device 107, and the processing device 108 are connected to each other by the bus 109 for transmitting information. The bus 109 may be a single bus. A different bus may be used for each element (device).

The projection device 101 includes a pair of right and left lenses, a display panel, and an optical member. The display panel and the optical member are housed in the frame. A pair of left and right display panels and a pair of left and right optical members may be provided to correspond to the right and left lenses. The projection device 101 displays a projection image corresponding to a virtual object on the display panel under the control of the processing device 108. The display panel may be a liquid crystal display or an organic EL (Electroluminescent) panel. The optical member guides light emitted from the display panel to the right and left lenses.

Each of the left lens and the right lens has a half mirror. The half mirror guides light representative of the real-world view to the corresponding eye of the user by transmitting the light. Light representative of virtual objects guided by the optical member is reflected by the half mirror in the corresponding eye of the user. The light representative of the virtual objects reflected by the half mirror is superimposed on the light representative of the real-world view transmitted through, and the superimposed light is incident on the eyes of the user. As a result, the user perceives the virtual objects as being in the real-world view. That is, the right and left lenses act as a transmissive display in front of the eyes.

The speaker 102 outputs sound. The sound output by the speaker 102 is, for example, sound output accompanying virtual objects. The speaker 102 is controlled by the processing device 108. The speaker 102 is, for example, disposed on the frame. Alternatively, the speaker 102 may not be included in the terminal apparatus 10 and may be disposed separately from the terminal apparatus 10.

The communication device 103 communicates with the server apparatus 20 wirelessly or by wire. In this embodiment, the communication device 103 includes an interface connectable to the network N and communicates with a communication device 203 (see FIG. 3) of the server apparatus 20 via the network N.

The GPS device 104 receives radio waves from satellites and generates location information from the received radio waves. The location information represents the location of the terminal apparatus 10. The location information may be of any format as long as the location is specified. In this embodiment, the latitude and the longitude are used as the location information. The location information may be obtained by using means other than the GPS device 104. For example, information to be received by the terminal apparatus 10 may include a name of a facility at which the terminal apparatus 10 is located and a position of the facility. The name and position of the facility may be specified by a beacon, or the like, provided in the facility.

Instead of the GPS device 104 or in addition to the GPS device 104, other similar sensors (e.g., a geomagnetic sensor, an acceleration sensor, an angular acceleration sensor, an inertial measurement unit (IMU)) may be used to detect a location of the terminal apparatus 10 and an orientation of the terminal apparatus 10.

Instead of the GPS device 104 or in addition to the GPS device 104, a VPS (Visual Positioning Service/System) may be used to detect a location of the terminal apparatus 10. In this case, the terminal apparatus 10 may include an imaging device that captures images in vicinity of the user. The terminal apparatus 10 may transmit images captured by the imaging device to the server apparatus 20. Alternatively, terminal apparatus 10 may transmit the captured images to a location specification server apparatus that specifies the location of the terminal apparatus 10. The server apparatus 20 (or the location specification server apparatus) may include a map in which captured images representative of real objects in the real space are associated with respective locations of the real objects. The server apparatus 20 (or the location specification server apparatus) may check a captured image against the map to specify the location in which the image has been captured, that is, the location of the terminal apparatus 10.

Alternatively, markers each indicating location information may be previously disposed in a real space, and a marker may be detected by the terminal apparatus 10 from an image captured by the imaging device.

The storage device 107 is a recording medium readable by the processing device 108. The storage device 107 includes, for example, a nonvolatile memory and a volatile memory. The nonvolatile memory is, for example, a ROM (Read Only Memory), an EPROM (Erasable Programmable Read Only Memory), and an EEPROM (Electrically Erasable Programmable Read Only Memory). The volatile memory is, for example, a RAM (Random Access Memory). The storage device 107 has a program PG1 stored therein. The program PG1 is used to control the terminal apparatus 10.

The processing device 108 comprises one or more CPUs (Central Processing Units), which are examples of processors. The processors are examples of computers.

The processing device 108 reads out the program PG1 from the storage device 107. The processing device 108 executes the program PG1 to act as an operation controller 110. The operation controller 110 may comprise a circuit, such as a DSP (Digital Signal Processor), an ASIC (Application Specific Integrated Circuit), a PLD (Programmable Logic Device), and an FPGA (Field Programmable Gate Array).

The operation controller 110 controls the operation of the terminal apparatus 10. For example, on the basis of virtual object data VD obtained from the server apparatus 20 via the communication device 103, the operation controller 110 controls the projection device 101 to superimpose a virtual object on a real-world view, and thereby displays the virtual object.

If the terminal apparatus 10 is a portable information device, such as a smartphone or a tablet, the terminal apparatus 10 includes an imaging device and a display instead of the projection device 101. The terminal apparatus 10 displays an image captured by the imaging device on the display. In response to acquiring from the server apparatus 20, a virtual object V corresponding to the virtual object data VD, the terminal apparatus 10 superimposes the acquired virtual object V on the displayed image, and thereby the virtual object V is displayed on the display.

### A-3. Server Apparatus 20

FIG. 3 is a block diagram illustrating a configuration of the server apparatus 20. The server apparatus 20 includes the communication device 203, a storage device 205, a processing device 206, and a bus 207. The communication device 203, the storage device 205, and the processing device 206 are connected to each other by the bus 207 for transmitting information. The bus 207 may be a single bus. A different bus may be used for each element (device).

The communication device 203 communicates with the terminal apparatus 10 by wireless or wired. In this embodiment, the communication device 203 includes an interface connectable to the network N and communicates with the terminal apparatus 10 via the network N.

The storage device 205 is a recording medium readable by the processing device 206. The storage device 205 includes, for example, a nonvolatile memory and a volatile memory. The nonvolatile memory is, for example, a ROM, an EPROM, and an EEPROM. The volatile memory is, for example, a RAM. The storage device 205 stores therein a program PG2, pieces of virtual object data VD (VD to VDn), and a virtual object map MP.

The program PG2 is used to control the server apparatus 20. Virtual object data VD is used to enable the terminal apparatus 10 to output a virtual object. Pieces of the virtual object data VD correspond to respective virtual objects, that is, they correspond one-to-one to virtual objects V. Hereinafter, virtual object data VD corresponding to a virtual object Vn is referred to as “virtual object data VDn,” accordingly. For example, virtual object data VD corresponding to a virtual object V1 refers to virtual object data VD1. The virtual object map MP is data indicating arrangement of the virtual objects V in the real space. Details of the virtual object map MP will be described later.

The processing device 206 comprises one or more CPUs, which are examples of processors. These processors are examples of computers.

The processing device 206 reads out the program PG2 from the storage device 205. The processing device 206 executes the program PG3 to act as an acquirer 210, a selector 212, a determiner 214, and a transmission controller 216. At least one of the acquirer 210, the selector 212, the determiner 214, and the transmission controller 216 may comprises a circuit, such as a DSP, an ASIC, a PLD, and an FPGA.

### A-4. Details of Processing Device 206

Detailed description will now be given of the acquirer 210, the selector 212, the determiner 214, and the transmission controller 216, which are implemented by the processing device 206 executing the program PG2. Prior to the explanations, details will be given of the virtual object map MP stored in the storage device 205.

FIG. 4 is a plan view illustrating a location relationship of objects in the virtual object map MP. FIG. 5 is a schematic diagram illustrating the virtual object map MP. The 3D virtual object map MP shown in FIG. 5 is viewed from a point P shown in FIG. 4 in a direction of an arrow D. In FIGS. 4 and 5, virtual objects V are stippled.

The virtual object map MP includes first shape information, pieces of second shape information, and pieces of second location information. The first shape information indicates shapes of real objects in the real space. The second shape information indicates a shape of a corresponding one of the virtual objects V1 to Vn. The second location information indicates a location of a corresponding one of the virtual objects V1 to Vn in the real space. In an example of FIG. 5, 3D real objects in the real space, such as buildings B1 to B4, trees T1 to T3, and a street S, are shown. As shown in FIG. 5, 3D virtual objects V1, V3, and V6 are superimposed on the real-world view and are displayed together with these 3D real objects.

The first shape information is prepared by 3D scanning of the real space. The second shape information and the second location information are obtained from the virtual object data VD. All the first shape information, the second shape information, and the second location information are not always included in the virtual object map MP. A 3D map as illustrated in FIG. 5 may be generated by reading these pieces of information that are separately stored in each case.

With use of the virtual object map MP, the user knows how real objects and virtual objects are seen from a certain position in the real space. For example, referring to FIG. 4, virtual objects V1 to V7 are arranged in the vicinity of the point P. When the user looks forward at the point P in the direction of the arrow D, only virtual objects V1, V3 and V6 are visible. For example, the virtual object V2 is invisible in the shadow of the tree T2. The virtual object V4 is invisible because it is inside the building B1. The virtual object V5 is invisible because it is in a region opposite to the point P (a direction opposite to the direction of the arrow D). The virtual object V7 is invisible because it is in a region opposite to the point P (the direction opposite to the direction of the arrow D) and is in the shadow of a tree T5.

Description will now be given of the functional components (see FIG. 3) of the processing device 206. The acquirer 210 acquires the first location information indicative of a location of the user in the real space. In this embodiment, the acquirer 210 acquires the location information generated by the GPS device 104 (see FIG. 2) as the first location information.

The selector 212 selects at least one piece of virtual object data VD from the virtual object data VD1 to VDn on the basis of the first location information, the first shape information, the pieces of the second shape information, and the pieces of the second location information. The virtual object data VD selected by the selector 212 is virtual object data VD to be transmitted to the terminal apparatus 10 via the transmission controller 216 (which will be described later). Hereinafter, the virtual object data VD selected by the selector 212 is also referred to as “selection object data.”

The selector 212 estimates from among the virtual objects V1 to Vn, at least one virtual object visually recognizable from the location of the user. The selector 212 then selects virtual object data VD (selection object data) corresponding to the estimated visible object. Thus, the virtual object map MP includes the first shape information, the pieces of the second shape information, and the pieces of the second location information. The selector 212 estimates how the real space (the real-world view) and the virtual objects V are seen at the location of the user on the basis of the virtual object map MP and the first location information acquired by the acquirer 210. The virtual objects seen from the location of the user are used to be visible objects. For example, when the location of the user indicates the point P illustrated in FIG. 4 and when an orientation of the user shows the direction of the arrow D, the selector 212 estimates that the visible objects are the virtual objects V1, V3, and V6. In this case, the selector 212 selects the virtual object data VD1, VD3, and VD6 as the selection object data.

The visual range of the user depends on face orientation of the user. The selector 212 may estimate a direction of user movement based on changes over time in the first location information and then estimate that the orientation of the user is along the direction of the user movement. If a face orientation of the user is unknown, visible objects in all directions may be estimated at the location of the user. For example, when the location of the user indicates the point P illustrated in FIG. 4 and when the face orientation of the user is unknown, the selector 212 estimates that the visible objects are virtual objects V1, V3, V5, and V6. In this case, the selector 212 selects the virtual object data VD1, VD3, VD5, and VD6 as the selection object data.

Here, the visible objects are virtual objects V that are visually recognizable by the user. However, the selector 212 may predict virtual objects V that will be visible by the user in the near future (e.g., in a few seconds, a few tens of seconds, or a few minutes). In other words, the selector 212 estimates the location of the user after a certain time based on at least one of the direction of the user movement and the speed of the user movement. The selector 212 estimates from among the virtual objects V1 to Vn, at least one predictable visible object that is visually recognizable from the estimated location of the user after the certain time. The selector 212 then selects virtual object data VD corresponding to the predictable visible object as the selection object data. In this case, the transmission controller 216 (which will be described later) transmits to the terminal apparatus 10, the virtual object data VD (selection object data) corresponding to the predictable visible object.

For example, when the current location of the user indicates the point P illustrated in FIG. 4 and when the user is walking in the direction of the arrow D, the user is predicted to reach a point Q after a certain time. The virtual object V2, which has been invisible at the point P in the shadow of the tree T2, is predicted to be visible from the point Q. In this case, the selector 212 estimates that the predictable visible object is the virtual object V2 and selects the virtual object data VD2 as the selection object data.

Thus, virtual object data VD on predictable visible objects, which will be potentially visible from the user in the near future, is transmitted in advance to the terminal apparatus 10 as the selection object data. By such advance transmission, the terminal apparatus 10 can smoothly display virtual objects V. Furthermore, even for a large amount of the selection object data, the time taken by transmission of the data is ensured and accordingly a display delay or a defective display of virtual objects V is less likely to occur. As a result, quality of a visual experience of the user using the terminal apparatus 10 is improved.

A direction of user movement may be estimated based on the direction of changes over time in the location of the user indicated by the first location information. Speed of user movement may be estimated based on displacement per unit time of the location of the user indicated by the first location information. The direction and speed of the user movement may be more accurately estimated by use of the first shape information. For example, when the user is located on an aisle, the user is predicted to probably move along the aisle. For example, it is predicted that a speed of user movement at a place including differences in the elevation (e.g., stairs or a slope) is less than that at a flat place. Therefore, the selector 212 may predict the direction and speed of the user movement using the first shape information in addition to the first location information.

The determiner 214 determines order of transmission of the virtual object data VD when pieces of the virtual object data VD are selected by the selector 212 (when there are multiple pieces of selection object data). The determiner 214 determines the order of transmission of the virtual object data VD by any of methods [1] to [3] described below.

There are two scenarios in transmission of pieces of the virtual object data VD: (i) the virtual object data VD are serially transmitted one by one, and (ii) the virtual object data VD are transmitted in parallel. In the latter scenario, the order of transmission of the virtual object data VD may be an order of start of transmission of the virtual object data VD. In this case, depending on amount of the virtual object data VD, completion of transmission of virtual object data VD started later may be earlier than completion of transmission of virtual object data VD started earlier.

[1] Transmit Virtual Objects V in Ascending Order of Distance from Location of User

A user may direct attention to a visible object disposed at a location near the user from among the visible objects. Furthermore, for predictable visible objects, a predictable visible object close to the current location of the user is highly likely to become visible earlier. Therefore, in the method [1], the determiner 214 determines that pieces of virtual object data VD for respective virtual objects V are transmitted in ascending order of a distance between a location of each virtual object V arranged in the real space and the location of the user.

For example, when the location of the user indicates the point P illustrated in FIG. 4 and when an orientation of the user shows the direction of the arrow D, the visible objects are those corresponding to the virtual object data VD1, VD3, and VD6 as illustrated in FIG. 5. In this case, the determiner 214 determines that the virtual object data VD are transmitted to the terminal apparatus 10 in the order of VD1, VD3, and VD6. According to the method [1], the virtual object data VD of the virtual objects V to which the user is likely to direct attention can be more reliably transmitted.

### [2] Transmit Virtual Objects V in Descending Order of Priority

When the priority is set to each of the virtual objects V, transmission of the virtual object data VD in descending order of the priority enables virtual objects V with high priorities to be reliably displayed on the terminal apparatus 10. In other words, in the method [2], when the priority is set to each of the virtual objects V, the determiner 214 determines that the pieces of virtual object data VD for the respective virtual objects V are transmitted in descending order of priority of each virtual object V.

It is envisaged that the order of the virtual objects is V7, V6, V5, V4, V3, V2, and V1 when the virtual objects V1 to V7 are arranged in descending order of priority. When the location of the user indicates the point P illustrated in FIG. 4 and when an orientation of the user shows the direction of the arrow D, the visible objects are virtual objects V1, V3, and V6 as illustrated in FIG. 5. In this case, the determiner 214 determines that the virtual object data are transmitted to the terminal apparatus 10 in the order VD6, VD3, and VD1. According to the method [2], the virtual object data VD of virtual objects V with high priorities can be more reliably transmitted.

The priority is set by, for example, a management person for the virtual objects V. For example, when the virtual objects V are paid advertisements by a company, the priority may be set according to advertisement rate. Specifically, a higher priority may be set to a virtual object V at a higher advertisement rate.

### [3] Transmit Virtual Objects in Descending Order of Proportion in View of User

The user is likely to direct attention to a visible object, the proportion of which in the viewing range of the user is high, that is, a visible object that looks large from the user from among the visible objects. Therefore, in the method [3], the determiner 214 estimates a proportion of each visible object displayed on the terminal apparatus 10 in the viewing range of the user. The determiner 214 then determines that the virtual object data VD are transmitted in descending order of the proportion of each visible object in the viewing range.

For example, when the location of the user indicates the point P illustrated in FIG. 4, and when an orientation of the user shows the direction of the arrow D, the proportions of the virtual objects in the viewing range of the user are higher in the order of V5, V1, and V3, as illustrated in FIG. 5. Therefore, the determiner 214 determines that the virtual object data are transmitted to the terminal apparatus 10 in the order of VD5, VD1, and VD3. According to the method [3], the virtual object data VD of the virtual objects V that have high proportions in the viewing range of the user and to which the user is likely to direct attention can be more reliably transmitted.

### [4] Transmit Virtual Objects in Descending Order of Amount of Data

A large amount of virtual object data VD may require a long time until the transmission is completed. Particularly in transmitting virtual object data VD for predictable visible objects, it is sometimes effective that a large amount of virtual object data VD be transmitted at an earlier timing. Therefore, in the method [4], the determiner 214 determines that the virtual object data VD are transmitted in descending order of amount of virtual object data VD.

It is envisaged that the order of the virtual objects is V6, V5, V4, V2, V1, V3, and V7 when the virtual objects are arranged in descending order of amounts of virtual object data VD1 to VD7. When the location of the user indicates the point P illustrated in FIG. 4, and when an orientation of the user shows the direction of the arrow D, the visible objects are virtual objects V1, V3, and V6. In this case, the determiner 214 determines that the virtual object data are transmitted to the terminal apparatus 10 in the order of VD6, VD1, and VD3. According to the method [4], the virtual object data VD in large amount can be more reliably transmitted.

In the methods [1] to [4], description is given of the order of transmission of the virtual object data VD as a specific example of visible objects when the user is located at the point P as shown in FIG. 4. However, the order of transmission when transmitting the predictable visible objects is determined in the same manner, similar to the methods [1] to [4].

The transmission controller 216 transmits the virtual object data VD to the terminal apparatus 10. Specifically, the transmission controller 216 controls the communication device 203 to transmit, to the terminal apparatus 10, at least one piece of the virtual object data VD selected by the selector 213 from among the pieces of the virtual object data VD stored in the storage device 205. When pieces of virtual object data VD are selected by the selector 213, the transmission controller 216 transmits the virtual object data VD in the order determined by the determiner 214.

The virtual object data VD transmitted by the transmission controller 216 are received by the terminal apparatus 10. The terminal apparatus 10 displays virtual objects V corresponding to at least one piece of virtual object data VD to be superimposed on the real-world view of the user, using the projection device 101. The user perceives the virtual objects V as actually existing in the peripheral real space.

### A-5. Operation of Processing Device 206

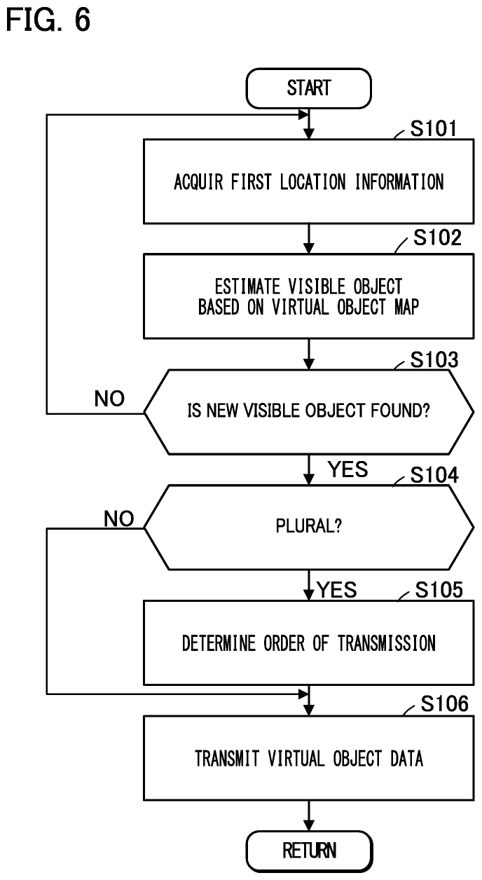

FIG. 6 is a flowchart illustrating an operation of the processing device 206. The processing device 206 repeats the processing in FIG. 6 at predetermined processing intervals. The processing device 206 acts as the acquirer 210 and receives the first location information from the terminal apparatus 10 (Step S101). The processing device 206 acts as the determiner 214 and maps the locations indicated by the first location information on the virtual object map MP to estimate visible objects (Step S102). At that time, the processing device 206 may estimate a direction and speed of user movement based on the first location information and estimate predictable visible objects.

The objects that are visible change with movement of the user. When a visible object is found which was not included at the time of the previous estimate of visible objects, this visible object is referred to as “a newly visible object.” When no newly visible object is found (Step S103: NO), the processing device 206 returns the processing to Step S101. When a newly visible object is found (Step S103: YES), the processing device 206 determines whether more than one newly visible object is provided (Step S104). When more than one newly visible object is provided (Step S104: YES), the processing device 206 acts as the determiner 214 and determines the order of transmission of the virtual object data VD by any of the methods [1] to [4] (Step S105). When more than one newly visible object is not provided (Step S104: NO), the processing device 206 moves the processing to Step S106.

The processing device 206 acts as the transmission controller 216 and transmits the virtual object data VD of newly visible objects to the terminal apparatus 10 (Step S106). When more than one newly visible object is found, the processing device 206 transmits the virtual object data VD in the order of transmission determined at Step S105. The processing device 206 subsequently returns the processing to Step S101.

### A-5. Summary of Embodiment

Thus, according to the embodiment, the server apparatus 20 estimates visible objects, which are virtual objects V that are visually recognizable by a user, on the basis of the location of the user in the real space, a shape of each real object located in the real space, a shape of each virtual object V, and arrangement of the virtual objects V in the real space. The server apparatus 20 transmits the virtual object data VD for the visible objects to the terminal apparatus 10.

As compared to collective transmission of virtual object data VD in an area as in conventional techniques, transmission and reception of unnecessary data are decreased. Specifically, the server apparatus 20 avoids transmission of virtual object data VD corresponding to virtual objects V that are not visually recognizable by the user. As a result, the processing loads on the server apparatus 20 and the terminal apparatus 10 are reduced and communication resources can be effectively utilized. For an extremely large virtual object V at a location far from the user, such as the virtual object V6, virtual object data VD is transmitted at an appropriate timing.

The server apparatus 20 estimates at least one predictable visible object, which is a virtual object visually recognizable from the location of the user after a certain time. The server apparatus 20 then transmits to the terminal apparatus 10, virtual object data VD corresponding to the predictable visible object. Since the virtual object data VD for the predictable visible objects, which potentially become visible from the user in the near future, is transmitted to the terminal apparatus 10 in advance, the terminal apparatus 10 can smoothly display the virtual objects V. Furthermore, since time for transmitting data is ensured, for a large amount of virtual object data VD, a display delay or a defective display of the virtual objects V is less likely to occur. As a result, the quality of a visual experience of the user using the terminal apparatus 10 can be improved.

In one example, when pieces of virtual object data VD are to be transmitted, the server apparatus 20 transmits the pieces of virtual object data VD for the respective virtual object V in ascending order of a distance between a location of each virtual object V arranged in the real space and the location of the user. As a result, the pieces of virtual object data VD for the respective virtual objects V, to which the user is likely to direct attention, can be more reliably transmitted.

In one example, when pieces of virtual object data VD are to be transmitted, the server apparatus 20 transmits the pieces of virtual object data VD for the respective virtual objects V in descending order of priority of each virtual object V. As a result, the pieces of virtual object data VD for the respective virtual objects V with high priorities can be more reliably transmitted.

In one example, when pieces of virtual object data VD are to be transmitted, the server apparatus 20 transmits the pieces of virtual object data VD for the respective virtual objects V in descending order of proportion of visible objects displayed on the terminal apparatus 10 in the viewing range of the user. The pieces of virtual object data VD for the respective virtual objects V can be more reliably transmitted which have high proportions in the view of the user and to which the user is likely to direct attention.

In one example, when pieces of virtual object data VD are to be transmitted, the server apparatus 20 determines that the pieces of virtual object data VD are transmitted in descending order of amount of the virtual object data VD. Therefore, a large amount of virtual object data VD can be more reliably transmitted.

### B. Modification

A modification of the foregoing embodiment will be described below. Two or more modes optionally selected from the following modifications may be combined with one another as appropriate as long as they do not conflict.

### B1: First Modification

In the foregoing embodiment, the terminal apparatus 10 includes only an eyeglasses-type terminal apparatus. The terminal apparatus 10 is not limited thereto and may include an eyeglasses-type terminal apparatus, and a portable device, such as a smartphone, a tablet, or a laptop personal computer. In this case, the eyeglasses-type terminal apparatus and the portable device are connected to each other. If the terminal apparatus 10 includes a portable device, the portable device may have one, some, or all of the functions of the operation controller 110.

### C: Other Matters

(1-1) The block diagrams used for explaining the embodiment described above illustrate blocks in units of functions. These functional blocks (components) are realized by an optional combination of at least one of hardware and software. The method for realizing each functional block is not particularly limited to any specific method. That is, each functional block may be realized by using one device combined physically or logically, or realized by directly or indirectly connecting (for example, using wired or wireless communication) two or more devices physically or logically separated from each other and using these plural devices. Each functional block may be realized by combining software with the one device or the plural devices mentioned above. Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that functions the transmitting is referred to as a transmission unit (transmitting unit) or a transmitter. In any case, as described above, there is no particular limitation on the method of implementation.

(1-2) Notification of information is not limited to the aspect/embodiment described in the present disclosure and may be performed by using other methods. For example, notification of information may be performed by physical layer signaling (for example, DCI (Downlink Control Information), UCI (Uplink Control Information)), higher layer signaling (for example, RRC (Radio Resource Control) signaling, MAC (Medium Access Control) signaling, broadcast information (MIB (Master Information Block), SIB (System Information Block))), other signals, or a combination thereof. The RRC signaling may also be referred to as an RRC message and may be, for example, an RRC Connection Setup message, an RRC Connection Reconfiguration message, or the like.

(1-3) Each aspect/embodiment described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), 6th generation mobile communication system (6G), xth generation mobile communication system (xG) (xG (x is an integer or a decimal number, for example)), FRA (Future Radio Access), NR (new Radio), New radio access (NX), Future generation radio access (FX), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-Wide Band), Bluetooth (registered trademark), and other appropriate systems and a next generation system enhanced, modified, created, and specified based thereon. Multiple systems may also be applied in combination (for example, at least one of LTE and LTE-A combined with 5G, and the like)

(1-4) The order of processing procedures, sequences, flowcharts, and the like in the aspect/embodiment described in the present disclosure may be rearranged as long as there is no contradiction. For example, the method described in the present disclosure presents elements of various steps using an exemplary order and is not limited to the presented specific order.

(1-5) The specific operations described in the present disclosure as performed by a base station may be performed by its upper node in some cases. In a network formed of one or plural network nodes having a base station, it will be apparent that various operations performed for communication with a terminal may be performed by at least one of a base station and other network nodes other than the base station (for example, MME, S-GW, and the like are assumed, but not limited thereto). Although the above description exemplifies that there is only one other network node other than a base station, the other network node may be a combination of multiple other network nodes (for example, MME and S-GW).

(1-6) Information and the like (* see Section “Information, Signal”) may be output from an upper layer (or a lower layer) to a lower layer (or an upper layer). Information and the like may be input and output via a plurality of network nodes.

(1-7) Input and output information and the like may be stored in a specific location (for example, a memory) or may be managed using a management table. Information and the like to be input and output may be overwritten, updated, or added. Output information and the like may be deleted. Input information and the like may be transmitted to another device.

(1-8) Determination may be made based on a value (0 or 1) expressed by one bit, based on a truth value (Boolean: true or false), or based on comparison of numerical values (for example, comparison with a predetermined value).

(1-9) Each aspect/embodiment described in the present disclosure may be used separately or in combination, or may be used as they are switched in accordance with execution. Notification of predetermined information (for example, notification of “being X”) is not limited to being performed explicitly, and it may be performed implicitly (for example, not notifying the predetermined information).

This disclosure has been described in detail. It is obvious to persons skilled in the art that the present disclosure is not limited to the embodiment described in the present disclosure. The present disclosure can be implemented as modifications and variations without departing from the spirit and scope of the present disclosure as defined by the descriptions in the claims. Accordingly, the descriptions in the present disclosure are for illustrative purposes and are not of any restrictive significance to the present disclosure.

(2-1) Regardless of whether software is referred to as software, firmware, middleware, microcode, or hardware description language, or some other name, the software should be interpreted broadly to mean instruction, instruction set, code, code segment, program code, program, subprogram, software module, application, software application, software package, routine, subroutine, object, executable file, execution thread, procedure, function, and the like. Software, instruction, information, and the like may be transmitted and received via a transmission medium. For example, when software is transmitted from a website, a server apparatus, or another remote source using at least one of a wired technology (such as coaxial cable, fiber optic cable, twisted pair, and DSL (Digital Subscriber Line)) and a wireless technology (such as infrared light and microwave), at least one of the wired and wireless technologies is included in the definition of the transmission medium.

(2-2) Information, signals, or the like described in the present disclosure may be represented by using any of various different technologies. For example, data, instruction, command, information, signal, bit, symbol, chip, or the like that may be mentioned throughout the entirety of the above description may be represented by voltage, current, electromagnetic wave, magnetic field or magnetic particle, optical field or photons, or an optional combination thereof. The terms described in the present disclosure and terms necessary for understanding the present disclosure may be replaced by terms having the same or similar meanings. For example, at least one of channels and symbols may be a signal (signaling). Signals may also be messages. In addition, CC (Component Carrier) may also be referred to as a carrier frequency, cell, frequency carrier, or the like.

(2-3) The terms “system” and “network” used in the present disclosure are used interchangeably.

(2-4) Information, parameters, and the like described in the present disclosure may be expressed using absolute values, relative values from predetermined values, or other information corresponding thereto. For example, a radio resource may be what is indicated by an index. The names used for the parameters described above are not restrictive in any respect. Mathematical equations and the like using these parameters may be different from those explicitly disclosed in the present disclosure. Since various channels (for example, PUCCH, PDCCH, and the like) and information elements may be identified by any suitable names, various names assigned to these various channels and information elements are not restrictive in any respect.

(2-5) In the present disclosure, terms such as “base station (BS),” “wireless base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier” may be used interchangeably. The base station may also be referred to as a macro cell, small cell, femtocell, picocell, or the like. The base station can accommodate one or plural (for example, three) cells. If the base station accommodates a plurality of cells, the entire coverage area of the base station may be divided into a plurality of smaller areas, each of which can also provide communication services via a base station subsystem (for example, a small indoor base station (RRH (Remote Radio Head)). The term “cell” or “sector” refers to a part or all of the coverage area of at least one of a base station and a base station subsystem that provides communication services at the coverage. In the present disclosure, a base station transmitting information to a terminal may be rephrased as a base station instructing control and operation based on information to a terminal.

(2-6) In the present disclosure, terms such as “mobile station (MS),” “user terminal,” “user equipment (UE),” and “terminal” may be used interchangeably. There are cases in which, by persons skilled in the art, the mobile station is also referred to as a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or as some other suitable terms.

(2-7) At least one of a base station and a mobile station may also be referred to as a transmitting device, a receiving device, a communication device, and the like. Note that at least one of the base station and the mobile station may be a device mounted on a moving body, a moving body itself, and the like. The moving body is a movable object and its moving speed is optional. The moving body naturally includes a case in which the moving body is in a stopped state. The moving body includes, for example, a vehicle, a transport vehicle, an automobile, a motorcycle, a bicycle, a connected car, an excavator, a bulldozer, a wheel loader, a dump track, a forklift, a train, a bus, a cart, a rickshaw, and a ship (ship and other watercraft), an airplane, a rocket, a satellite, a drone (Registered Trademark), a multi-copter, a quad-copter, a balloon, and an object mounted thereon, and is not limited thereto. The moving body may be a moving body that runs autonomously based on operation instructions. The moving body may be a vehicle (for example, a car or an airplane), a moving body that moves in an unmanned manner (for example, a drone or a self-driving car), or a robot (manned or unmanned). At least one of the base station and the mobile station may include a device that does not necessarily move during a communication operation. For example, at least one of the base station and the mobile station may be an IoT (Internet of Things) device such as a sensor. The base station in the present disclosure may be rephrased as a user terminal. For example, each aspect/embodiment of the present disclosure may be applied in a configuration in which communication between a base station and a user terminal is replaced by communication between plural user terminals (for example, it may be referred to as D2D (Device-to-Device), V2X (Vehicle-to-Everything), or the like). In this case, it is permissible to have a configuration in which the user terminal has functions the base station mentioned above has. Terms such as “uplink” and “downlink” may also be replaced by terms corresponding to terminal-to-terminal communication (for example, “side”). For example, an uplink channel, a downlink channel, or the like may be rephrased as a side channel. Similarly, the user terminal in the present disclosure may be rephrased as a base station. In this case, it is permissible to have a configuration in which the base station has functions the user terminal mentioned above has.

(3-1) The term “determining” or “determining” used in the present disclosure may encompass a wide variety of actions. “Determining” or “determining” may include regarding some actions such as judging, calculating, computing, processing, deriving, investigating, looking up, search, inquiry (for example, searching in a table, database, or other data structures), and ascertaining, as it has been “determined” or “determined.” Furthermore, “determining” or “determining” may also include regarding some actions such as receiving (for example, receiving information), transmitting (for example, transmitting information), input, output, and accessing (for example, accessing data in a memory), as it has been “determined” or “determined.” Furthermore, “determining” or “determining” may also include regarding some actions such as resolving, selecting, choosing, establishing, and comparing, as it has been “determined” or “determined.” That is, “determining” or “determining” may include regarding some actions have been “determined” or “determined.” In addition, “determining (determining)” may be rephrased as “assuming,” “expecting,” “considering,” and the like.

(3-2) The terms “connected,” “coupled,” or any variations thereof mean any direct or indirect connection or coupling between two or more elements and one or more intermediate elements may be present between two elements that are “connected” or “coupled” to each other. The coupling or connection between elements may be physical coupling or connection, logical coupling or connection, or a combination thereof. For example, “connection” may be rephrased as “access.” When such terms are used in the present disclosure, two elements are regarded to be “connected” or “coupled” to each other by using at least one of one or more wires, cables, and printed electrical connections, and as some non-limiting and non-exhaustive examples, by using electromagnetic energy having wavelengths in radio-frequency regions, microwave regions, and light (both visible and invisible) regions, and the like.

(3-3) A reference signal may be abbreviated as RS (Reference Signal) or may be referred to as a pilot, depending on the applied standards.

(3-4) The description “based on” used in the present disclosure does not mean “based only on” unless explicitly stated otherwise. In other words, the description “based on” means both “based only on” and “based at least on.”

(3-5) Any reference to elements using an address term such as “first,” “second,” or the like used in the present disclosure generally does not limit the amount or order of these elements. Such address terms may be used in the present disclosure as a convenient method of distinguishing between two or more elements. Therefore, reference to first and second elements does not mean that only two elements may be employed or that the first element must precede the second element in some manner.

(3-6) “Means” in the configuration of each apparatus described above may be replaced with “unit,” “circuit,” “device,” and the like.

(3-7) In the present disclosure, when “include,” “including,” and variations thereof are used, these terms are intended to be inclusive in a manner similar to the term “comprising.” The term “or” used in the present disclosure is intended not to be an exclusive OR.

(3-8) In the present disclosure, for example, during translation, if articles such as a, an, and the in English are added, the present disclosure may include a case in which a noun following these articles is plural.

(3-9) In the present disclosure, the term “A and B are different” may mean “A and B are different from each other.” Note that the term may also mean “A and B are each different from C.” Terms such as “leave,” “coupled,” or the like may also be interpreted in the same manner as “different.”

(4) It is obvious to persons skilled in the art that the present invention is not limited to the embodiment described in the present specification. The present invention can be implemented as modifications and variations without departing from the spirit and scope of the present invention as defined by the descriptions in the claims. Accordingly, the descriptions in the present specification are for illustrative purposes and are not of any restrictive significance to the present invention. More than one mode selected from the modes exemplified in this specification may be combined with one another.

### DESCRIPTION OF REFERENCE SIGNS

1 . . . system, 10 . . . terminal apparatus, 20 . . . server apparatus, 101 . . .
projection device, 103 . . . communication device, 104 . . . GPS device,
203 . . . communication device, 205 . . . storage device, 206 . . .
processing device, 210 . . . acquirer, 212 . . . selector, 214 . . . determiner,
216 . . . transmission controller, MP . . . virtual object map, N . . .
communication network, V (V1 to Vn) . . . virtual object, VD (VD1 to
Vn) . . . virtual object data.

1. A virtual object data selection apparatus comprising:
a selector configured to select at least one piece of virtual object data from plural pieces of virtual object data corresponding one-to-one to a plurality of virtual objects based on:
first location information indicative of a location of a user in a real space;
first shape information indicative of a shape of a real object located in the real space;
plural pieces of second shape information, each indicative of a shape of a corresponding one of the plurality of virtual objects; and
plural pieces of second location information, each indicative of a location in which a corresponding one of the plurality of virtual objects is arranged in the real space; and
a transmission controller configured to transmit the at least one piece of virtual object data selected by the selector to a display device, wherein:
the display device is configured to display a virtual object based on the at least one virtual object data to be superimposed on a viewing range of the user in the real space, and
the selector is configured to:
estimate at least one visible object visually recognizable from the location of the user from among the plurality of virtual objects; and
select virtual object data corresponding to the at least one visible object as the at least one piece of virtual object data.

2. The virtual object data selection apparatus according to claim 1, wherein:
the selector is configured to:
estimate a location of the user after a certain time based on at least one of a direction of movement of the user and a speed of movement of the user;
estimate at least one predictable visible object visually recognizable from the estimated location of the user after the certain time from among the plurality of virtual objects; and
select virtual object data corresponding to the at least one predictable visible object as the at least one piece of virtual object data.

3. The virtual object data selection apparatus according to claim 1, further comprising a determiner configured to, when the selector selects plural pieces of virtual object data, determine order of transmission of the selected plural pieces of virtual object data,
wherein the determiner is configured to determine that the selected plural pieces of virtual object data for respective virtual objects are transmitted in ascending order of a distance between a location of each of the virtual objects arranged in the real space and the location of the user.

4. The virtual object data selection apparatus according to claim 1, further comprising a determiner configured to, when the selector selects plural pieces of virtual object data, determine order of transmission of the selected plural pieces of virtual object data, wherein:
a priority is set to each of the plurality of virtual objects, and
the determiner determines that the selected plural pieces of virtual object data for respective virtual objects are transmitted in descending order of the priority of each of the virtual objects.

5. The virtual object data selection apparatus according to claim 1, further comprising a determiner configured to, when the selector selects plural pieces of virtual object data, determine order of transmission of the selected plural pieces of virtual object data, wherein:
the plurality of pieces of virtual object data selected by the selector correspond to a plurality of visible objects estimated to be visible from the location of the user, and
the determiner is configured to:
estimate a proportion of each of the visible objects displayed on the display device in the viewing range; and
determine that the selected plural pieces of virtual object data are transmitted in descending order of the proportion of each of the plurality of visible objects in the viewing range.

6. The virtual object data selection apparatus according to claim 1, further comprising a determiner configured to, when the selector selects plural pieces of virtual object data, determine order of transmission of the selected plural pieces of virtual object data,
wherein the determiner is configured to determine that the selected plural pieces of virtual object data for respective virtual objects are transmitted in descending order of amount of each of the virtual object data.
